(19) United States
(12) Patent Application Publication
(10) Pub. No.: US 2003/0043212 A1
(43) Pub. Date: Mar. 6, 2003

(54) Image-forming system having a graphic user interface with print option representation using icons

(76) Inventor: Karl Heinz Kremer, Rochester, NY (US)

Correspondence Address: Richard K. Clark, BRINKS HOFER GILSON & LIONE, P.O. Box 10395, Chicago, IL, 60610-0395, US

(21) Appl. No.: 10/235,878

(22) Filed: Sep. 5, 2002

Related U.S. Application Data
(60) Provisional application No. 60/317,535, filed on Sep. 5, 2001.

(51) Int. Cl. G09G 5/00

(52) U.S. Cl. 345/838

(57) ABSTRACT

An image-forming system has a graphic user interface (GUI) responsive to an image-forming management functionality and a document or image viewing functionality, which provide a page level print option representation of a print job. The print option representation includes one or more graphical images of page options selected or assigned to each page in a print job. The graphical images include icon and/or thumbnail images showing the selected or assigned page options.

### RELATED APPLICATIONS

The present application claims the benefit of the filing date of U.S. Provisional Patent Application No. 60/317,535 entitled “IMAGE-FORMING SYSTEM HAVING A GRAPHIC USER INTERFACE WITH PRINT OPTION REPRESENTATION” and filed on Sep. 5, 2001.

The following copending and commonly assigned U.S. patent application was filed on the same day as this application. The commonly assigned application relates to and further describes other aspects of the present application and is incorporated herein by reference in its entirety.

U.S. patent application Ser. No. ______, entitled “IMAGE-FORMING SYSTEM HAVING A GRAPHIC USER INTERFACE WITH PRINT OPTION REPRESENTATION USING THUMBNAIL IMAGES,” Attorney Reference No. 10432/128 (10252), filed on ______, and now U.S. Pat. No. ______.

### FIELD

This invention generally relates to image-forming systems having a graphic user interface. More particularly, this invention relates to image-forming machines and methods using a graphic user interface with page level print option representation of a print job.

### BACKGROUND

An image-forming machine transfers images from original documents onto paper or other medium to create a finished product such as a booklet, a folded brochure, or a tabbed notebook. The original documents may be in hard copy (paper or other medium), in electronic form (floppy disk, compact disc, and the like), or may be transmitted over a network such as the Internet. A “print job” is the combination of original documents with the instructions for producing the finished product.

Many image-forming machines have a graphic user interface (GUI) for visually representing and controlling the transfer of images for a print job. The GUI permits the creation and manipulation of relationships and associations among various components of the image-forming machine and the print job. These relationships and associations may be displayed using a hierarchical approach like a tree structure or file folder structure or using some alternate form of visual indication.

The instructions for a print job include print options for the entire print job and page options for specific pages in the print job. The page options represent an exception to the print options assigned to the whole job. The print and page options include the type of paper or medium (color, size, transparency, tabs, cover, etc.), staple positions, punched holes, image shift, folding, offset stacking, printed sides, edge trimming, rotation, and the like. The GUI usually displays a list of icons showing a summary of the page options. The icons typically convey that a page has page options assigned, but usually do not display the specific options for the page. In one approach, an icon is displayed to indicate a page with tabs but shows no other page options. To obtain more information about specific page options, a user usually has to open and review the properties for each page. In addition, icons usually are assigned when the print job is compiled and cannot be changed or updated when a user assigns new page options.

### SUMMARY

This invention provides an image-forming system having a graphic user interface with a page level print option representation of a print job. The print option representation includes one or more graphical images of the page options selected or assigned to each page. Graphical images include icon and thumbnail images of the page showing the selected page options.

The image-forming system may have a graphic user interface and an image-forming management functionality. The image-forming management functionality creates one or more icons. The graphic user interface shows the icons. The icons display at least one page option.

The image-forming system may also have a graphic user interface, an image viewing functionality and an image-forming management functionality. At least one of the image viewing functionality and the image-forming management functionality creates one or more icons. The graphic user interface shows the icons. The icons display at least one page option.

In one method for representing print options on a graphic user interface in an image-forming machine, one or more page options are displayed on an icon. The icon is shown on a graphic user interface.

In another method for representing print options on a graphic user interface in an image-forming machine, a page option is applied to a page in a print job. An icon is created in response to the page option. The icon is associated with the page from the print job.

In a further method for representing print options on a graphic user interface in an image-forming machine, a page option is applied to a page in a print job. An icon is selected from a list of predetermined icons in response to the page option. The icon is associated with the page from the print job.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGURES

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

FIG. 1 represents a block diagram of an image-forming machine having a graphic user interface with a page level print option representation of a print job according to an embodiment.

FIG. 2 shows representations of icons according to another embodiment.

FIG. 3 shows representations of thumbnail images according to a further embodiment.

FIG. 4 shows a flowchart of a first method for representing print options in a graphic user interface on an image-forming machine.

FIG. 5 shows a flowchart of a second method for representing print options in a graphic user interface on an image-forming machine.

FIG. 6 shows a flowchart of a third method for representing print options in a graphic user interface on an image-forming machine.

### DETAILED DESCRIPTION OF THE PREFERRED EMBODIMENTS

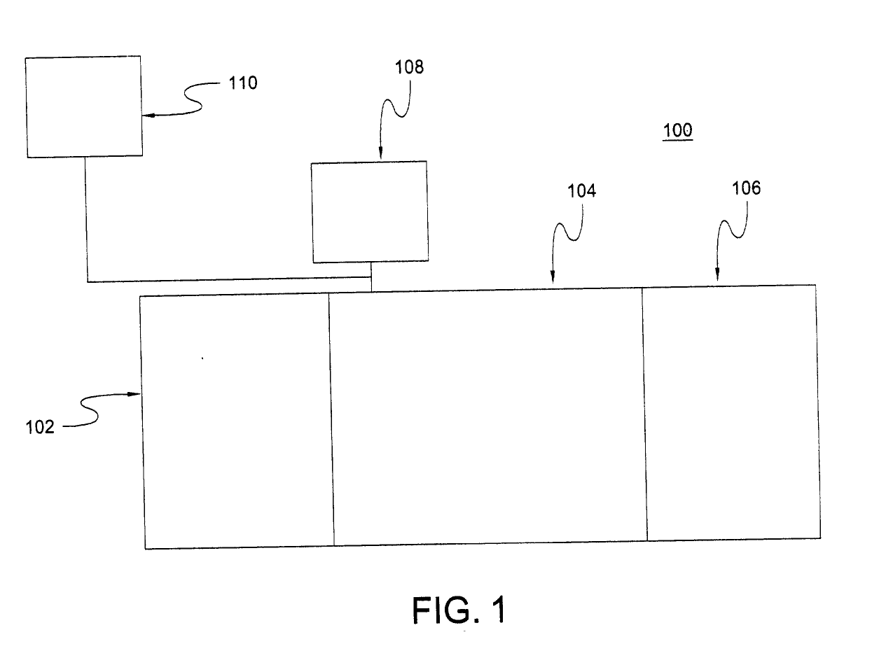

FIG. 1 represents a block diagram of an image-forming machine 100 having a graphic user interface (GUI) 110 with a page level print option representation of a print job according to an embodiment. The print option representation includes one or more graphical images of the page options selected or assigned to each page. Graphical images include icon and thumbnail images of the page showing the selected page options. Each graphical image displays or visually illustrates one or more of the selected page options. Page options include the type of medium (color, transparency, tab, cover, etc.), the type of finishing (folded, stapled, hole-punched, etc.), and the like. While particular configurations and arrangements are shown, other configurations and arrangements may be used including those with other and additional components.

The image-forming machine 100 may be an electrophotographic device such as one of the Digimaster® digital printers manufactured by Heidelberg Digital L.L.C. located in Rochester, N.Y. The image-forming machine 100 also may be another electrophotographic machine, a photocopy machine, a printing device, or the like. In addition to the GUI 110, the image-forming machine 100 has a feeder 102, a marking engine 104, a finisher 106, and a printer user interface 108. The image-forming machine 100 may have other equipment. The feeder 102, the marking engine 104, the finisher 106, and the printer user interface 108 may be separate or integrated components. The printer user interface 108 may be a display unit with push buttons or other activation means for inputting control parameters in the image-forming machine 100.

The feeder 102 provides the printing or copying sheets to the printing engine 104. The sheets may be one or a combination of paper, transparencies, and other medium. The sheets may be configured with pre-punched holes, tabs, and the like. The marking engine 104 may have a photoconductor (not shown), one or more chargers (not shown), an exposure machine (not shown), a toning station (not shown), and a fuser station (not shown). The marking engine 104 may have fewer and additional components. In operation, the photoconductor is selectively charged and optically exposed to form an electrostatic latent image on the surface. Toner is deposited onto the photoconductor surface. The toner is charged, thus adhering to the photoconductor surface in areas corresponding to the electrostatic latent image. The toner image is transferred onto the sheet. In the fuser station, the sheet is heated causing the toner to fix or adhere to the paper or other medium. The sheet exits the marking engine 104 and enters the finisher 106, which may discharge the sheet as is or may perform one or more finishing operations such as stapling, folding, and inserting an inserted sheet.

The GUI 110 may be a separate component such as a dedicated desktop or other personal computer operatively connected to the image-forming machine 100. The GUI 110 also may be integrated with the printer user interface 108 or with other components of the image-forming machine 100. The GUI 110 is operatively connected to the logic control unit (not shown) in the image-forming machine 100. Operatively connected includes transmission or communication means such as electrical, radio, network, and the like. The GUI 110 and the logic control unit may be integrated into the same component. The logic control unit is connected to control the feeder 102, the marking engine 104, the finisher 106, and the printer user interface 108. The GUI 110 comprises a display screen and an interfacing means such as a touch screen (not shown), a keyboard (not shown), a mouse (not shown), a track ball (not shown), or a combination thereof. The GUI 110 may include dialog boxes, menus, buttons, list boxes, and other GUI elements, and alternate keyboard command and mouse shortcuts, as well as other alternative physical input devices.

The GUI 110 provides visual interaction with the image-forming machine 100 using a document or image viewing management functionality and an image-forming management functionality, which may be incorporated into the GUI 110. The document or image viewing functionality and image-forming management functionality may be partially or completely incorporated in the logic control unit or another component of the image-forming machine 100. The image viewing and image-forming management functionalities may be implemented via a plug-in architecture. A plug-in architecture allows enhancements and updates to be incorporated in a simpler and more efficient manner and without requiring recompilation of the program codes that implement the functionalities. Other architectures may be used.

The document or image viewing functionality provides a viewing window for viewing electronic images of the original documents in a print job. Adobe Acrobat®, Version 5.0 software program, manufactured by Adobe Systems, Inc. located in San Jose, Calif., provides the document or image viewing functionality. Other document viewing software applications may be used.

The image-forming management functionality integrates applications that implement, control, or manage the image-forming machine 100. The image-forming management functionality is a graphical user interface that visually represents objects (documents, tickets, other entities, operations, and the like) with elements such as icons, tree structures, pull-down menus, pop-up menus, tool buttons, slide controls, and the like which are well known in the art. A user may interact with the image-forming management functionality using various interaction means such as the touch screen, the mouse, the track ball, and the keyboard. Such interaction with the visual representations results in manipulation of the underlying objects. While the image-forming management functionality may have an object-oriented appearance, the implementation of the functionality may be by an object oriented programming language or a non-object oriented programming language. In one aspect, the image-forming management functionality is implemented by an ImageSmart® Document Mastering SmartBoard™ software application used with Digimaster® digital printers manufactured by Heidelberg Digital L.L.C. located in Rochester, N.Y. Other image-forming management software applications may be used.

The GUI 110 provides a print option representation having one or more graphical images of the page options selected or assigned to each page. The graphical images include icons, thumbnail images, or a combination thereof. The icons and thumbnail images are provided by the image-forming management and image-viewing document management functionalities. Icons include software-generated representative images of original documents. Thumbnail images include smaller views of original documents in an electronic file format. The image-forming management functionality provides the icons and the document image-viewing functionality provides the thumbnail images. The GUI 110 may provide an icon and/or thumbnail image for every page with a page option assigned to a document. The GUI 110 also may provide an icon and/or a thumbnail image for every page.

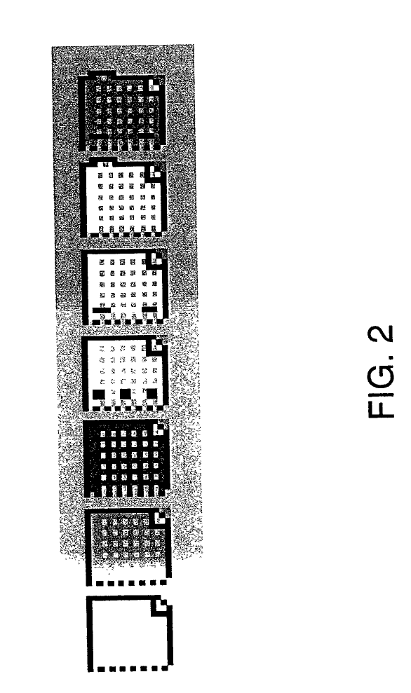

FIG. 2 shows representations of icons according to another embodiment. The icons show the following page options—no special options, red media (the background is red), blue media (the background is blue), three-hole punch (the icon has three square-shaped dots on left side), two staples (the icon has two slit-shaped dots on the left side), tab media (the icon has a tab portion), and red tab media with two staples (the background is red, the icon has a tab portion, and the icon has two slit-shaped dots on the left side). Each icon may indicate one or more page options. Other or additional page options may be used. Due to size limitations, each icon may be limited to showing only one page option. Each icon may be limited to a feature group (e.g., show a staple setting applied but not the specific staple setting).

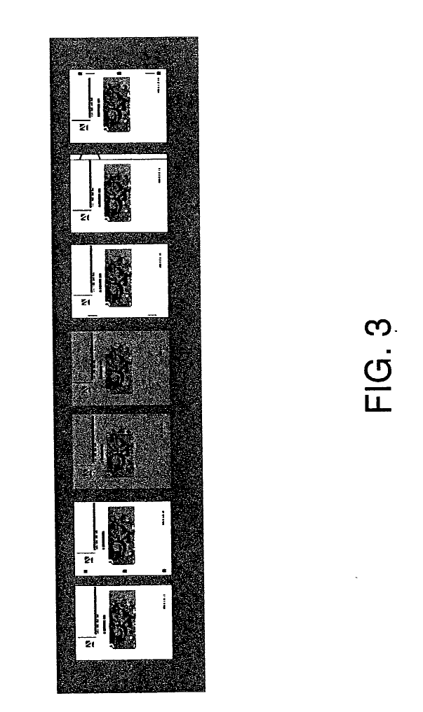

FIG. 3 shows representations of thumbnail images according to a further embodiment. The thumbnail images show the following page options—no special options, three-hole punch, blue media, red media, two staples, tab media, and three-hole punch and two staples printed on the back side. Each thumbnail image may indicate one or more page options. Other or additional page options may be used. The image-forming management functionality in GUI 110 may modify the thumbnail images from the document or image viewing management functionality based on the page options for the print job. The image-forming management functionality may create the thumbnail images. Various page options may be represented including a colored background to indicate a certain paper color, darkened circles to indicate punched holes, black marks to indicate staple positions, an added tab to the paper to indicate tab stock media, a generic mark to indicate all other page level print options (e.g., image shift, folding, offset stacking, printed sides, edge trimming, rotation, and a different output device), and the like.

The modified thumbnail images may be generated when page level print options are assigned or modified. The thumbnail images also may be re-created prior to modification to provide a correct representation of the original document. The automatic regeneration of thumbnail images may be disabled for performance improvements. The system keeps a copy of the unmodified thumbnail image, which is used to create the visual representation of the page level print options.

When thumbnails are created for a duplex job, the special marks and their location on the thumbnail image may be modified so that they are displayed in the correct location for the backsides of pages. If the software determines that a page will be printed on the backside of a sheet of paper, the punch and staple marks may be moved to the right edge of the thumbnail. The tab mark may be moved to the left edge of the image.

If multiple page options are selected at the same time, the changes may be applied in a certain order to represent all the options on the icon or thumbnail image. Any changes to the page size (e.g., tabs) may be applied first. All changes putting new marks on the page (e.g. staples, punched holes) may be applied second. All changes to the background color may be applied last. The changes may be made using different sequences.

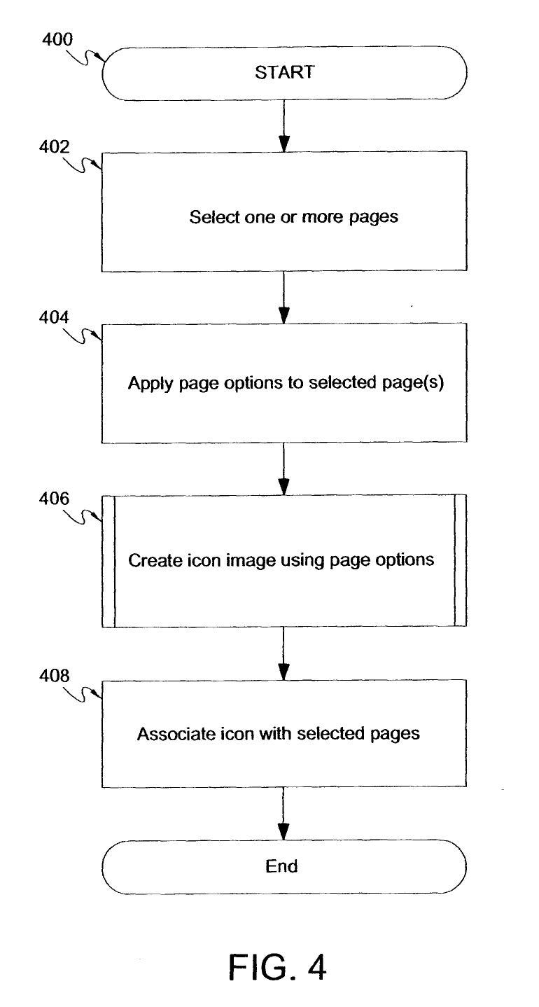

FIG. 4 shows a flowchart of a first method for representing print options in a graphic user interface on an image-forming machine. As previously discussed, the graphic user interface has an image-forming management functionality and a document or image viewing functionality. At start, the document or image viewing management functionality opens 400 a file for a print job. The image-forming management functionality selects 402 one or more pages. The image-forming management functionality applies 404 one or more page options to the selected page(s). The image-forming management functionality uses the page options to create 406 an icon. For example, darkened circles and black lines may be added to indicate punched holes and staples. The color of the background is changed to indicate the color of the paper to use. The image-forming management functionality associates 408 the icon with the selected page(s).

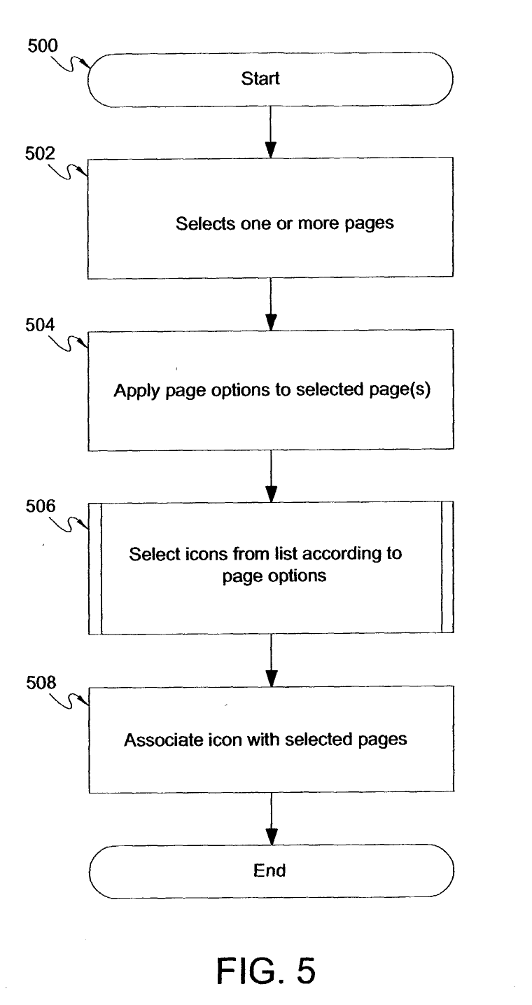

FIG. 5 shows a flowchart of a second method for representing print options in a graphic user interface on an image-forming machine. As previously discussed, the graphic user interface has an image-forming management functionality and a document or image-viewing functionality. At start, the document or image-viewing functionality opens 500 a file for a print job. The image-forming management functionality selects 502 one or more pages. The image-forming management functionality applies 504 one or more page options to the selected page(s). The image-forming management functionality uses the page options to select 506 an icon from a list according to the page options. The list includes predefined icons corresponding to the page options. The page color is applied to indicate the color of the paper stock. The image-forming management functionality associates 508 the icon with the selected page(s).

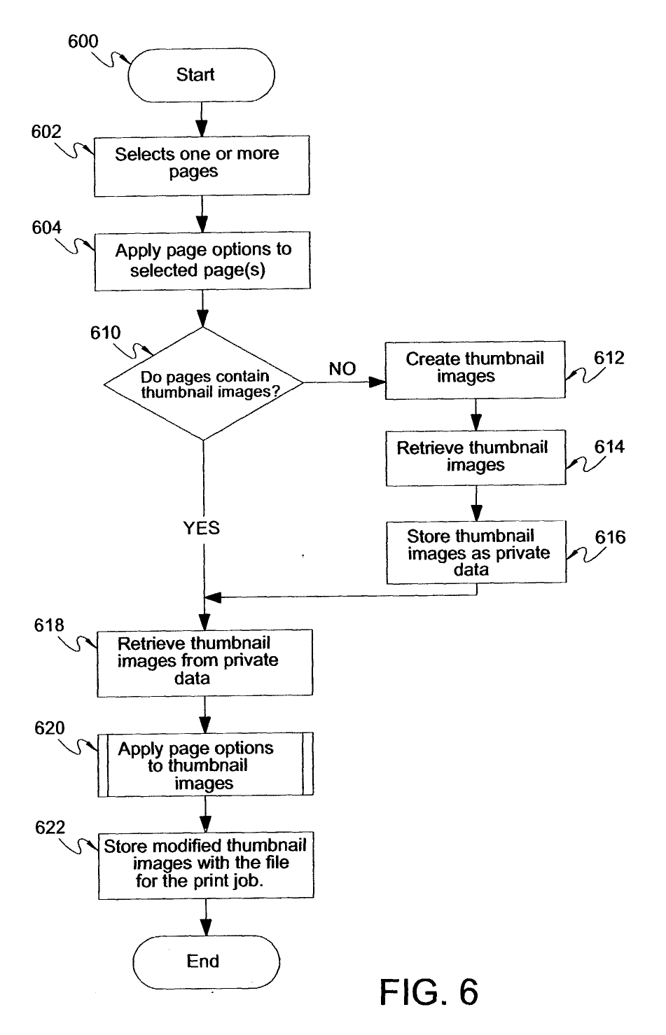

FIG. 6 shows a flowchart of a third method for representing print options in a graphic user interface on an image-forming machine. As previously discussed, the graphic user interface has an image-forming management functionality and a document or image viewing functionality. At start, the document or image viewing functionality opens 600 a file for a print job. The image-forming management functionality selects 602 one or more pages. The image-forming management functionality applies 604 one or more page options to the selected page(s). The document or image viewing functionality determines 610 whether the selected pages contain initial thumbnail images. If the selected pages do not have initial thumbnail images, the document or image viewing functionality creates 612 initial thumbnail images of the selected pages. The document or image viewing functionality retrieves 614 and stores 616 the initial thumbnail images with the selected pages. The image-forming management functionality retrieves 618 the initial thumbnail images. The image-forming management functionality applies 620 the page options to the initial thumbnail images. The image-forming management functionality stores 622 the new/modified thumbnail images with the file for the print job.

Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. An image-forming system comprising:
a graphic user interface; and
an image-forming management functionality;
where the image-forming management functionality creates at least one icon, where the graphic user interface shows that at least one icon, and where the at least one icon displays at least one page option.

2. The image-forming system according to claim 1, where the at least one page option comprises at least one of a type of medium and/or a type of finishing.

3. The image-forming system according to claim 1, where the at least one page option is assigned by the print job.

4. The image-forming system according to claim 1, where the at least one page option is selected.

5. The image-forming system according to claim 1, where the image-forming management functionality modifies the at least one icon to display at least one other page option.

6. The image-forming system according to claim 1, further comprising an image viewing functionality.

7. The image-forming system according to claim 6, where the image forming functionality modifies the at least one icon to display at least one other page option.

8. An image-forming system, comprising:
a graphic user interface;
an image viewing functionality; and
an image-forming management functionality;
where at least one of the image viewing functionality and the image-forming management functionality creates at least one icon, where the graphic user interface shows the at least one icon, and where the at least one icon displays at least one page option.

9. The image-forming system according to claim 8, where the at least one page option comprises at least one of a type of medium and/or a type of finishing.

10. The image-forming system according to claim 8, where at least one of the image viewing functionality and the image-forming management functionality modifies the at least one icon to display at least one other page option.

11. A method for representing print options on a graphic user interface in an image-forming machine, comprising:
displaying at least one page option on a icon; and
showing the icon on a graphic user interface.

12. The method according to claim 11, further comprising modifying the icon to display another page option.

13. The method according to claim 11, further comprising assigning the at least one page option from a print job.

14. The method according to claim 11, further comprising selecting the at least one page option.

15. A method for representing print options on a graphic user interface in an image-forming machine, comprising:
applying a page option to a page in a print job;
creating an icon in response to the page option; and
associating the icon with the page.

16. The method according to claim 15, further comprising modifying the icon in response to another page option for the page.

17. A method representing print option on a graphic user interface in an image-forming machine, comprising:
applying a page option to a page in a print job;
selecting an icon from a list of predetermined icons in response to the page option; and
associating the icon with the page.

18. The method according to claim 17, further comprising modifying the icon in response to another page option for the page.

19. The method according to claim 17, further comprising:
applying another page option to the page; and
selecting another icon from the list of predetermined icons in response to the other page option.

24. The method according to claim 19, further comprising associating the other icon with the page.
